(19) United States
(12) Patent Application Publication
(10) Pub. No.: US 2014/0251077 A1
(43) Pub. Date: Sep. 11, 2014

(54) BICYCLE PEDAL

(71) Applicant: Chung-I Chen, Taichung City (TW)

(72) Inventor: Chung-I Chen, Taichung City (TW)

(21) Appl. No.: 13/792,210

(22) Filed: Mar. 11, 2013

(51) Int. Cl. B62M 3/08

(52) U.S. Cl. CPC B62M 3/08
USPC 74/594.4

(57) ABSTRACT

A bicycle pedal includes a pedal body and a central shaft, the pedal body having a through hole opened therethrough, two openings of the through hole being defined as a first opening end and a second opening end respectively, the central shaft having a threaded portion and a limiting segment formed at two ends thereof respectively, at least one limiting portion formed axially along the limiting segment, the central shaft pivotally passing through the through hole of the pedal body with the threaded portion being exposed out of the first opening end, the limiting portion being extended from the second opening end of the through hole. Under this arrangement, the pedal body is positioned between the threaded portion and the limiting portion of the central shaft because of the through hole.

### BACKGROUND OF THE INVENTION

1. Field of the Invention

The present invention relates to a bicycle component, and more particularly to a bicycle pedal which has low cost and can be assembled with the bicycle easily.

2. Description of Related Art

A conventional bicycle pedal comprises a pedal body and a central shaft. The central shaft is rotatable relative to the pedal body. The central shaft has a connecting end defined at one end thereof. A plurality of threaded grooves is defined around an outer periphery of the connecting end, so that the connecting end is threaded with a crank of a bicycle. The central shaft has a terminal end defined at another end thereof. A threaded hole is opened through the terminal end. A bolt is threaded with the threaded hole so that the pedal body is restricted by the bolt and does not depart from the central shaft.

However, the conventional bicycle pedal has some disadvantages described as following.

In order to produce the threaded hole at the terminal end of the central shaft, the manufacturer has to apply a hole opening procedure and a threading procedure to the central shaft; moreover, in order to avoid from the pedal body departing from the central shaft, another procedure, namely, to threaded the bolt with the threaded hole is further applied. Under such condition, the production of the conventional bicycle pedal costs money and takes time.

Furthermore, another conventional bicycle pedal is achieved by applying an external force at the terminal end of the central shaft so as to expand the terminal end of the central shaft for restricting said bicycle pedal; however, in order to enhance the structural strength of the central shaft, a heat treatment procedure is applied to the central shaft, and the method, apply an external force at the terminal end of the central shaft, is only applicable to the central shaft without the heat treatment procedure.

The present invention has arisen to mitigate and/or obviate the disadvantages of the conventional.

### SUMMARY OF THE INVENTION

The main objective of the present invention is to provide a bicycle pedal.

To achieve the objective, the bicycle pedal comprises a pedal body and a central shaft, the pedal body having a through hole opened therethrough, two openings of the through hole being defined as a first opening end and a second opening end respectively, the central shaft having a threaded portion and a limiting segment formed at two ends thereof respectively, at least one limiting portion formed axially along the limiting segment, the central shaft pivotally passing through the through hole of the pedal body with the threaded portion being exposed out of the first opening end, the limiting portion being extended from the second opening end of the through hole. Wherein, the bicycle pedal comprises a first bearing and a second bearing; the first bearing and the second bearing are respectively assembled at two ends of the through hole; the first bearing has a first ring plate extended from one end thereof; the second bearing has a second ring plate extended from one end thereof; the first ring plate abuts against the first opening end; the second ring plate abuts against the second opening end; the central shaft passes through the first bearing, and then is inserted into the through hole; thereafter, the central shaft passes through the second bearing; a separating ring is assembled with the limiting segment of the central shaft; the limiting portion is laterally abutted against one surface of the separating ring; the second ring plate of the second bearing is abutted against another surface of the separating ring; a covering member is assembled at the second opening end of the pedal body; the covering member shields the limiting portion, the separating ring and the second bearing completely; the pedal body further has a two treading faces oppositely defined thereon; a plurality of skidproof members is extruded from the two treading faces; the limiting portion is formed as extruded block.

Under this arrangement, the pedal body is positioned between the threaded portion and the limiting portion of the central shaft because of the through hole, so that the pedal body axially rotates relative to the central shaft and does not depart from the central shaft.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of a first embodiment of a bicycle pedal of the present invention;

FIG. 2 is a perspective view for showing a central shaft is assembled in a pedal body;

FIG. 3 is a perspective view for showing a limiting portion is formed on the central shaft;

FIG. 4 is a partial enlarged view of FIG. 3;

FIG. 5 is a perspective view of the present invention;

FIG. 6 is a cross-sectional view along a line 6-6 in FIG. 5;

FIG. 7 is a perspective view for showing two limiting portions are formed on the central shaft symmetrically as respect to the central axis of the central shaft;

FIG. 8 is a partial enlarged view of FIG. 7;

FIG. 9 is a perspective view for showing a second embodiment of the present invention which is applied for assembling with a city bike; and

FIG. 10 is a perspective view for showing a third embodiment of the present invention which is applied for assembling with a mountain bike.

### DETAILED DESCRIPTION OF THE INVENTION

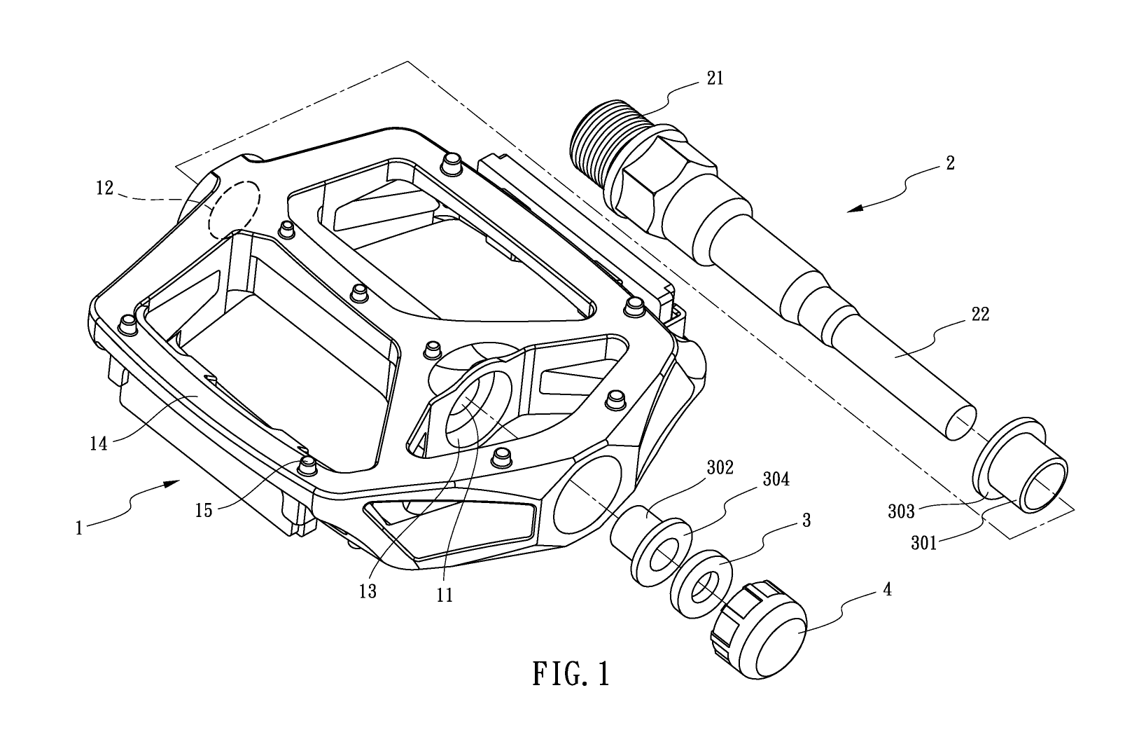

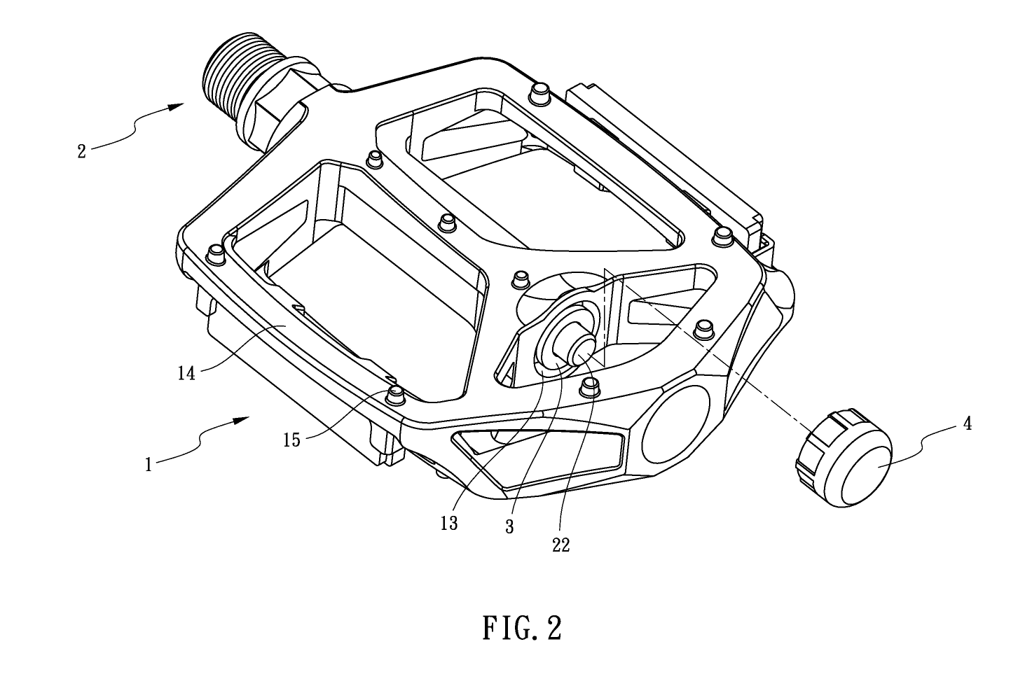

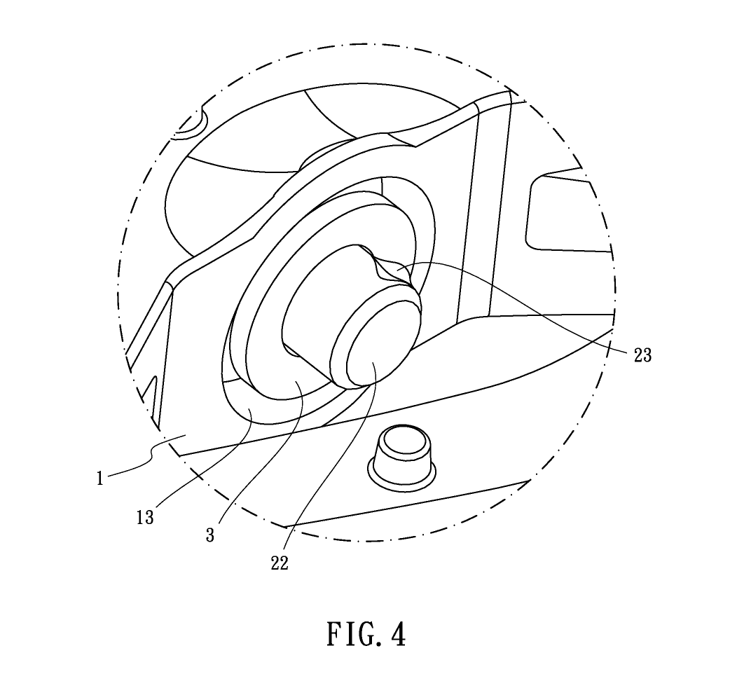

Referring to FIGS. 1-5, a bicycle pedal in accordance with a first embodiment of the present invention comprises a pedal body 1 and a central shaft 2. The pedal body 1 has a through hole 11 opened thereon. Two openings of the through hole 11 are defined as the first opening end 12 and the second opening end 13 respectively. In this embodiment, the pedal body 1 is formed as BMX type (bicycle motocross type). The central shaft 2 has a threaded portion 21 and a limiting segment 22 formed at two ends thereof respectively. At least one limiting portion 23 is formed axially along the limiting segment 22 (The number of the limiting portion 23 is not limited by the present invention.). The central shaft 2 pivotally passes through the through hole 11 of the pedal body 1 with the threaded portion 21 being exposed out of the first opening end 12, so that the threaded portion 21 is threaded with a crank (not shown) of a bicycle. The limiting portion 23 is extended from the second opening end 13 of the through hole 11. Under this arrangement, the pedal body 1 is positioned between the threaded portion 21 and the limiting portion 23 of the central shaft 2 because of the through hole 11, so that the pedal body 1 axially rotates relative to the central shaft 2 and does not depart from the central shaft 2.

External forces are applied around the surface of the outer periphery of the limiting segment 22, so that the limiting segment 22 of the central shaft 2 are extruded and the limiting portion 23 are formed; moreover, the limiting portion 23 is extended from the second opening end 13 of the through hole 11, so that the pedal body 1 is positioned by the central shaft 2 and rotates axially relative to the central shaft 2.

Referring to FIGS. 1-6, the detailed characteristics of the present invention are further described as following.

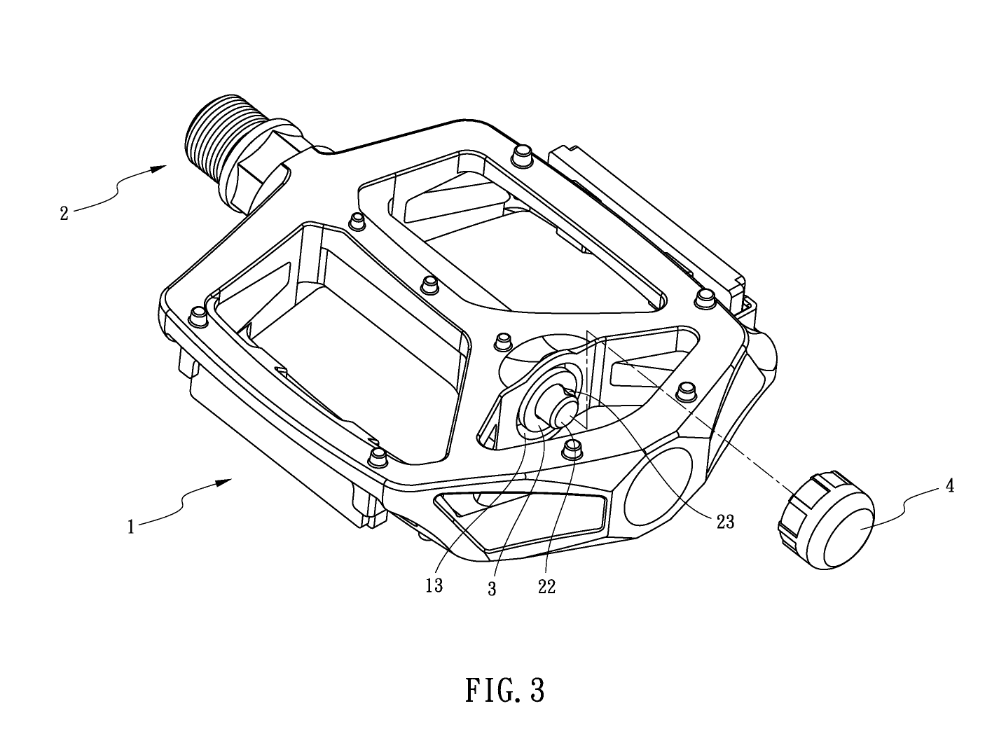

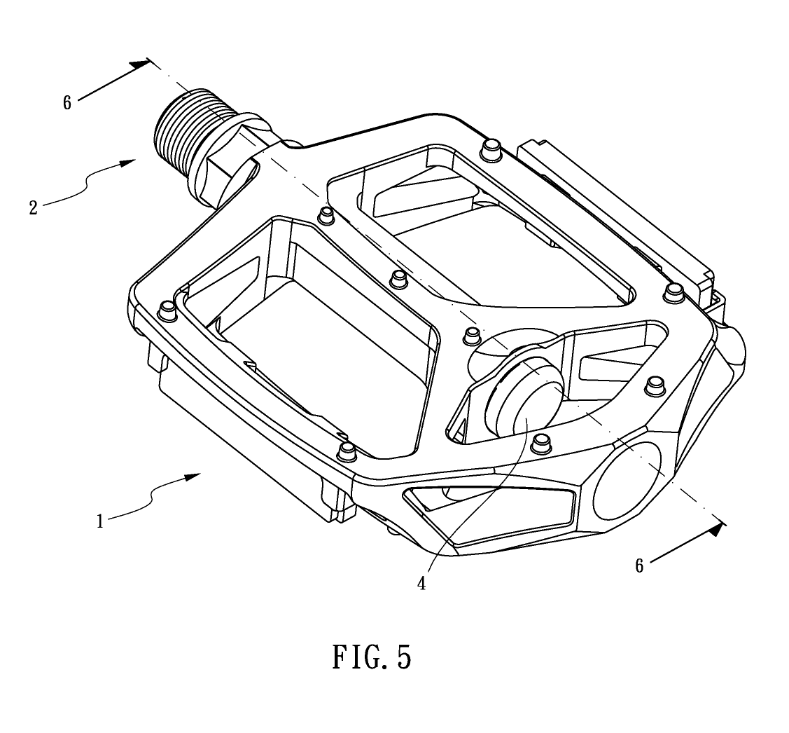

The bicycle pedal comprises a first bearing 301 and a second bearing 302. The first bearing 301 and the second bearing 302 are respectively assembled at two ends of the through hole 11. The first bearing 301 has a first ring plate 303 extended from one end thereof. The second bearing 302 has a second ring plate 304 extended from one end thereof. The first ring plate 303 abuts against the first opening end 12. The second ring plate 304 abuts against the second opening end 13. The central shaft 2 passes through the first bearing 301, and then is inserted into the through hole 11; thereafter, the central shaft 2 passes through the second bearing 302. Under this arrangement, the pedal body 1 is rotatable relative to the central shaft 2 via the first bearing 301 and the second bearing 302. The bicycle pedal further comprises a separating ring 3. The separating ring 3 is assembled with the limiting segment 22 of the central shaft 2, so that the separating ring 3 is assemble in the second opening end 13. As shown in FIG. 3, the limiting portion 23 is laterally abutted against one surface of the separating ring 3. The second ring plate 304 of the second bearing 302 is abutted against another surface of the separating ring 3. The bicycle pedal further comprises a covering member 4. The covering member 4 is assembled at the second opening end 13 of the pedal body 1, and the covering member 4 shields the limiting portion 23, the separating ring 3 and the second bearing 302 completely, as shown in FIG. 5.

In addition, the pedal body 1 further has a two treading faces 14 oppositely defined thereon. A plurality of skidproof members 15 is extruded from the two treading faces 14.

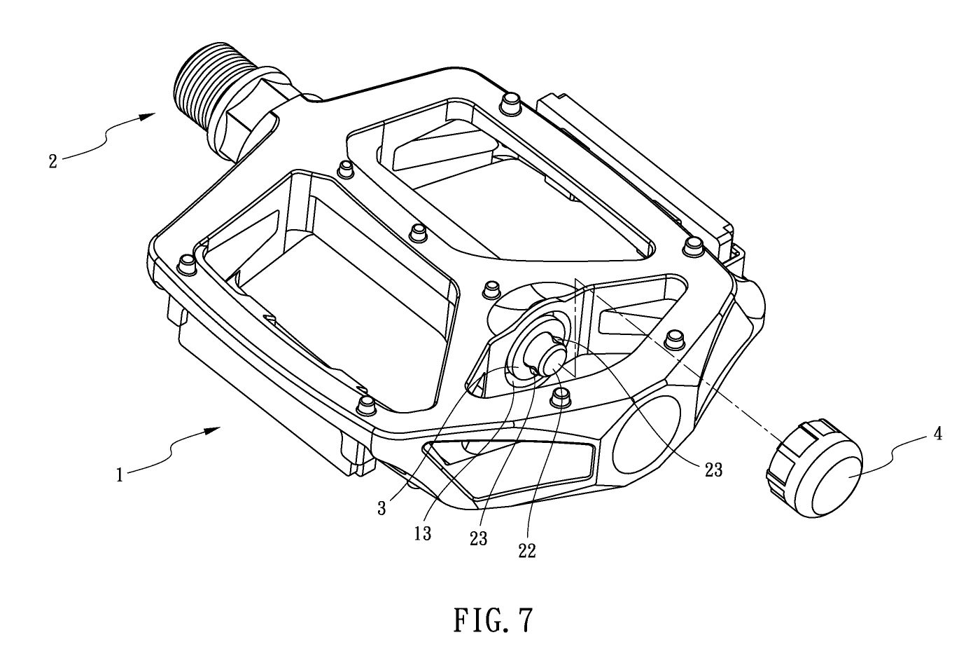

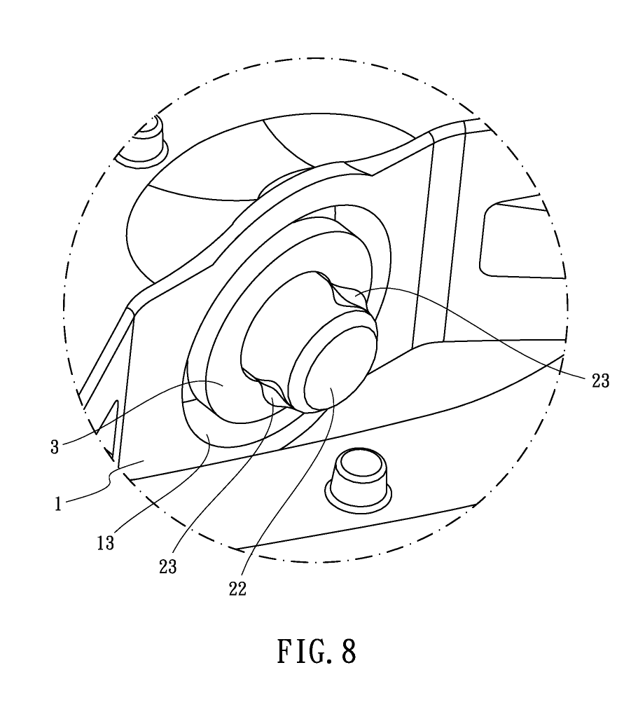

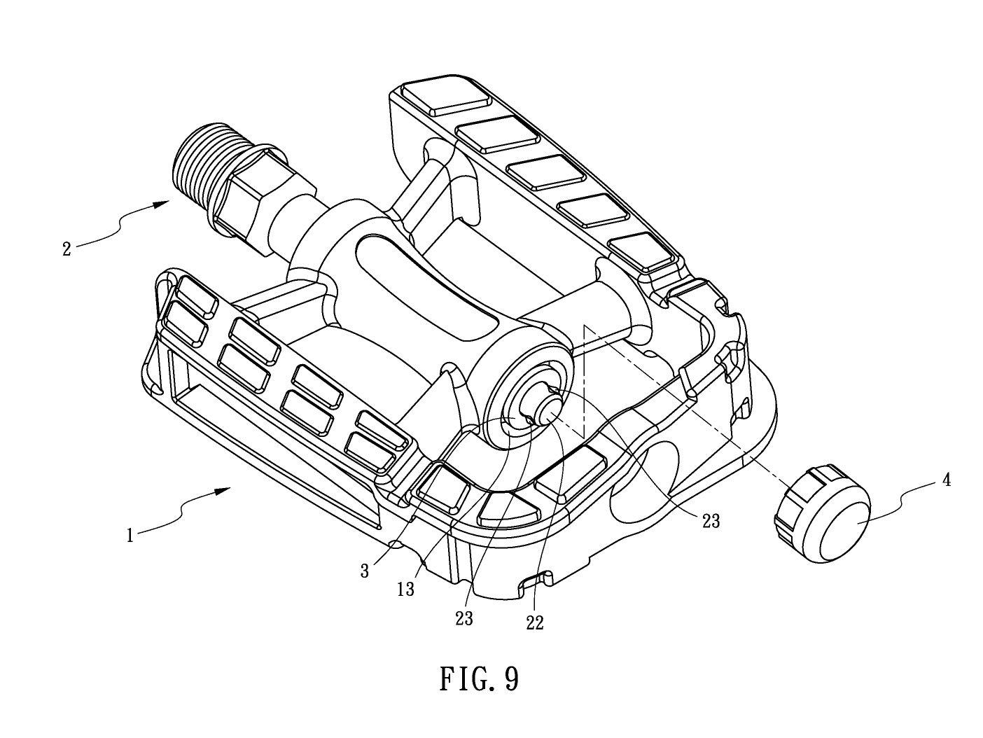

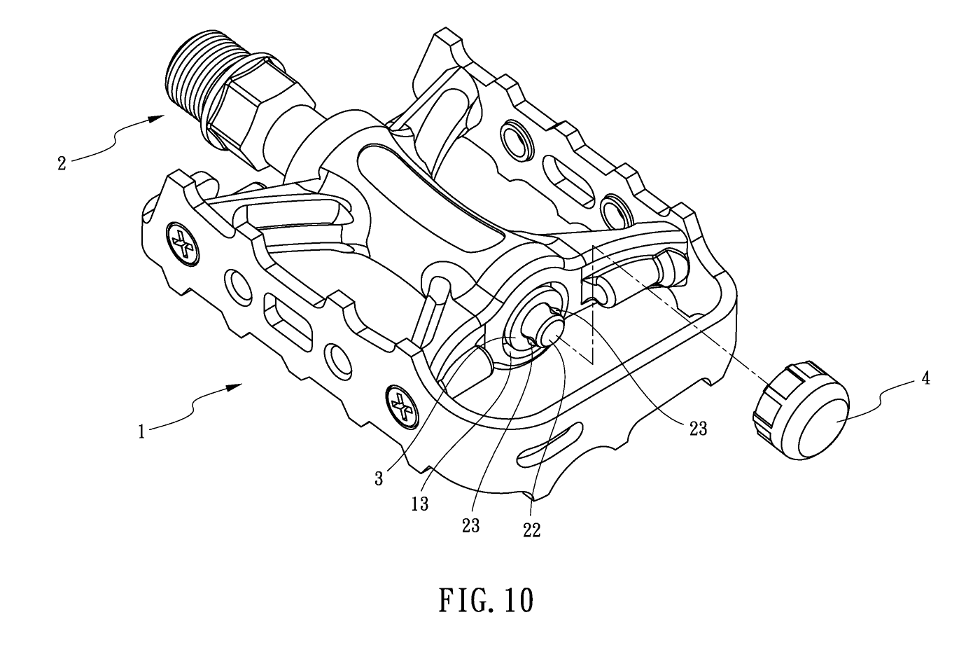

Referring to FIGS. 7-8, another embodiment of the central shaft 2 shows that two limiting portions 23 are formed on the central shaft 2 symmetrically as respect to the central axis of the central shaft 2. Further referring to FIGS. 9-10, a second embodiment and a third embodiment of the present invention are shown respectively and are applied for assembling with a city bike and a mountain bike respectively.

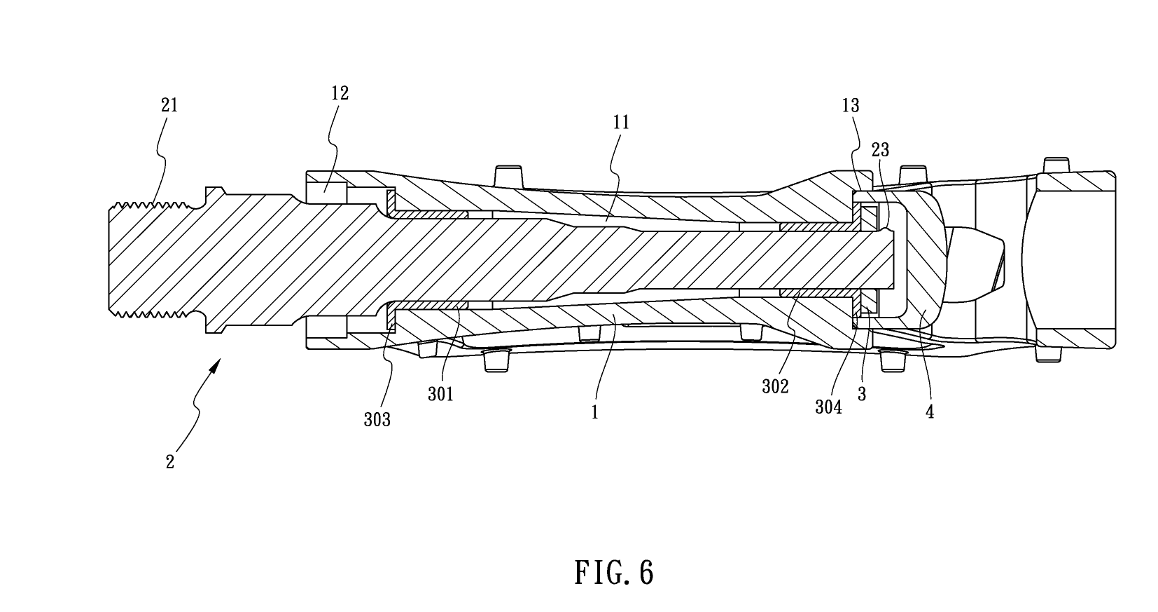

Furthermore, referring to FIG. 6, the central shaft 2 has a further limiting segment which is adjacent to the limiting segment 22. A cross-sectional diameter of the limiting segment 22 is shorter than a cross-sectional diameter of the further limiting segment. The first bearing 301 corresponds to the further limiting segment. The second bearing 302 corresponds to the limiting segment 22.

Although the invention has been explained in relation to its preferred embodiment, it is to be understood that many other possible modifications and variations can be made without departing from the spirit and scope of the invention as hereinafter claimed.

What is claimed is:

1. A bicycle pedal comprising:
a pedal body and a central shaft;
the pedal body having a through hole opened therethrough, two openings of the through hole being defined as a first opening end and a second opening end respectively; and
the central shaft having a threaded portion and a limiting segment formed at two ends thereof respectively, at least one limiting portion formed axially along the limiting segment, the central shaft pivotally passing through the through hole of the pedal body with the threaded portion being exposed out of the first opening end, the limiting portion being extended from the second opening end of the through hole;
wherein the pedal body is positioned between the threaded portion and the limiting portion of the central shaft because of the through hole, so that the pedal body axially rotates relative to the central shaft and does not depart from the central shaft.

2. The bicycle pedal as claimed in claim 1, wherein the bicycle pedal comprises a first bearing and a second bearing; the first bearing and the second bearing are respectively assembled at two ends of the through hole; the first bearing has a first ring plate extended from one end thereof; the second bearing has a second ring plate extended from one end thereof; the first ring plate abuts against the first opening end; the second ring plate abuts against the second opening end; the central shaft passes through the first bearing, and then is inserted into the through hole; thereafter, the central shaft passes through the second bearing.

3. The bicycle pedal as claimed in claim 2, wherein a separating ring is assembled with the limiting segment of the central shaft; the limiting portion is laterally abutted against one surface of the separating ring; the second ring plate of the second bearing is abutted against another surface of the separating ring.

4. The bicycle pedal as claimed in claim 2, wherein a covering member is assembled at the second opening end of the pedal body; the covering member shields the limiting portion, the separating ring and the second bearing completely.

5. The bicycle pedal as claimed in claim 1, wherein the pedal body further has a two treading faces oppositely defined thereon; a plurality of skidproof members is extruded from the two treading faces.

6. The bicycle pedal as claimed in claim 1, wherein the limiting portion is formed as extruded block.
